(19) United States
(12) Patent Application Publication
(10) Pub. No.: US 2006/0230997 A1
(43) Pub. Date: Oct. 19, 2006

(54) Soil injection apparatus

(76) Inventor: Hal E. Kirk, Westville, FL (US)

Correspondence Address: ROGERS TOWERS, P.A., 1301 RIVERPLACE BOULEVARD, SUITE 1500, JACKSONVILLE, FL, 32207, US

(21) Appl. No.: 11/406,686

(22) Filed: Apr. 19, 2006

Related U.S. Application Data
(60) Provisional application No. 60/672,786, filed on Apr. 19, 2005.

(51) Int. Cl. A01C 23/00

(52) U.S. Cl. 111/118

(57) ABSTRACT

A soil injection apparatus for injecting solids, liquids or mixtures beneath the surface of the ground, the apparatus having one or more injector lances mounted to a skid plate, such that the lances can be forced into the ground using hydraulic cylinders, and storage tanks to retain materials to be injected, the material being delivered into the lances and the ground using compressed air. A viewing tube is provided such that the operator can visually determine the correct amount of material to be injected. The apparatus is readily mountable to tractors, front-end loaders, forklifts and similar vehicles.

This application claims the benefit of U.S. Provisional Patent Application Ser. No. 60/672,786, filed Apr. 19, 2005.

### BACKGROUND OF THE INVENTION

This invention relates generally to the field of devices, apparatuses or equipment used to inject gases, liquids or solids into the soil, and more particularly to such apparatuses that are components of or mounted to mobile vehicles such that the apparatuses can be rapidly moved from one location to the next.

Apparatuses for injecting or forcing gases, liquids or solids into the ground are known. Such apparatuses are used for example to inject fertilizer and other nutrients, pesticides, herbicides, water, air and other gases to break up or treat the soil, substances to increase soil stability, etc. The apparatuses may be hand-held, pulled as a trailer, attached to powered arms or lifts, mounted on vehicles or incorporated as a component of a vehicle. Examples of hand-held apparatuses are seen in U.S. Pat. No. 612,745 to Morris, U.S. Pat. No. 1,512,758 to Gravatt, U.S. Pat. No. 2,055,266 to Thomas, U.S. Pat. No. 2,177,792 to Taylor, U.S. Pat. No. 2,242,789 to McFee, U.S. Pat. No. 2,713,834 to Shirley, U.S. Pat. No. 2,885,977 to Fabus, U.S. Pat. No. 2,975,735 to Purvance, U.S. Pat. No. 3,025,806 to Peck, U.S. Pat. No. 3,299,842 to Bingham, U.S. Pat. No.3,405,669 to Nimrock, U.S. Pat. No. 3,774,556 to Poll, U.S. Pat. No. 3,783,804 to Platz, U.S. Pat. No. 4,705,218 to Daniels, U.S. Pat. No. 4,872,411 to Nagy, U.S. Pat. No. 5,050,340 to Seifert, U.S. Pat. No. 5,322,085 to Prothe, U.S. Pat. No. 5,558,030 to Ward, and U.S. Pat. No. 5,802,996 to Baxter. Examples of devices pulled by vehicles, attached to vehicles, or self-powered are seen in U.S. Pat. No. 1,871,529 to Karshner, U.S. Pat. No. 2,789,522 to Barton, U.S. Pat. No. 3,136,274 to Townsend, U.S. Pat. No. 450,073 to Baker, U.S. Pat. No. 3,546,886 to Jones et al., U.S. Pat. No. 3,598,068 to Rosendahl, U.S. Pat. No. 3,602,166 to Peterson, U.S. Pat. No. 4,034,686 to Collins, U.S. Pat. No. 4,178,860 to Hines et al., U.S. Pat. No. 4,233,915 to Kordon, U.S. Pat. No. 4,658,738 to Zinck, U.S. Pat. No. 4,903,618 to Blair, U.S. Pat. No. 6,182,586 to Hunt et al., and U.S. Pat. No. 6,758,152 to Steadman.

It is an object of this invention to provide a soil injection apparatus that improves upon the known devices. It is a further object to provide such an apparatus that is capable of injecting liquids, solids or a mixture thereof into the soil, that is adapted as an attachment to be mounted onto various types of vehicles, that provides a means to rapidly load and inject the liquid, solid or mixture into the soil, that provides a means to visually ascertain the quantity of material being injected, and that can be rapidly moved to successive injection sites.

### SUMMARY OF THE INVENTION

The invention is a ground or soil injection apparatus for injecting or depositing liquids, solids or mixtures thereof beneath the surface of the ground with minimal intrusion such that plant roots and the like are not damaged. The apparatus can be temporarily or permanently mounted to a vehicle or attached to tractors, front-end loaders, forklifts, or similar motorized vehicles using appropriate mounting means in a manner whereby the apparatus can be elevated above ground level for movement or transport.

The soil injector apparatus comprises in general a skid plate or platform, means to attach the skid plate to a vehicle, at least one and preferably multiple generally vertically disposed injector lances or hollow spikes capable of being extended beneath the skid plate and into the soil, means to rapidly insert and retract the lances into and from the soil, means to store and deliver a quantity of liquid, solid or mixture into said lances, and means to expel or inject the liquid, solid or mixture into the soil with the lances in the extended position. The apparatus is preferably provided with a means for the operator to visually verify the quantity of liquid, solid or mixture prior to injection. In a preferred embodiment, the injector lances are extended and retracted hydraulically, while the liquid, solid or mixture is delivered to the lances pneumatically using compressed air.

### BRIEF DESCRIPTION OF THE DRAWINGS

FIG. 1 is a perspective view of the invention.

FIG. 2 is a view of the injection lances in the retracted position and illustrating the extended injection position in dashed lines.

FIG. 3 is a partial view of the invention showing an alternative embodiment for the invention, wherein the contents of two storage tanks are fed into a single viewing tube.

### DETAILED DESCRIPTION OF THE INVENTION

The invention is an injection apparatus that injects a treating material, such as a liquid, solid or a mixture of liquid and solid, beneath the surface of the soil or ground with minimal disturbance of the ground surface and minimal damage to plant and tree roots. A primary suitable use of the invention is to inject fertilizer, pesticides, water or like beneficial agents into the root zone of plants and trees.

The soil injection apparatus is primarily adapted as an attachment that is mounted onto the maneuverable arms of a tractor, front-end loader, forklift or similar vehicle, such that the apparatus can be lifted from the ground surface for movement and transport, and such that the hydraulic system and/or pneumatic compressor system of the vehicle, if present, can be utilized to operate the apparatus. In the event that necessary hydraulic or pneumatic systems are not part of the vehicle, such systems are incorporated in the apparatus itself so as to be self-powered. The mounting or hitching system is preferably of standard configuration known in the industry for attaching implements to such vehicles. Alternatively, the apparatus can be mounted in suitable manner more permanently to a vehicle or may be constructed as an integral component of a vehicle.

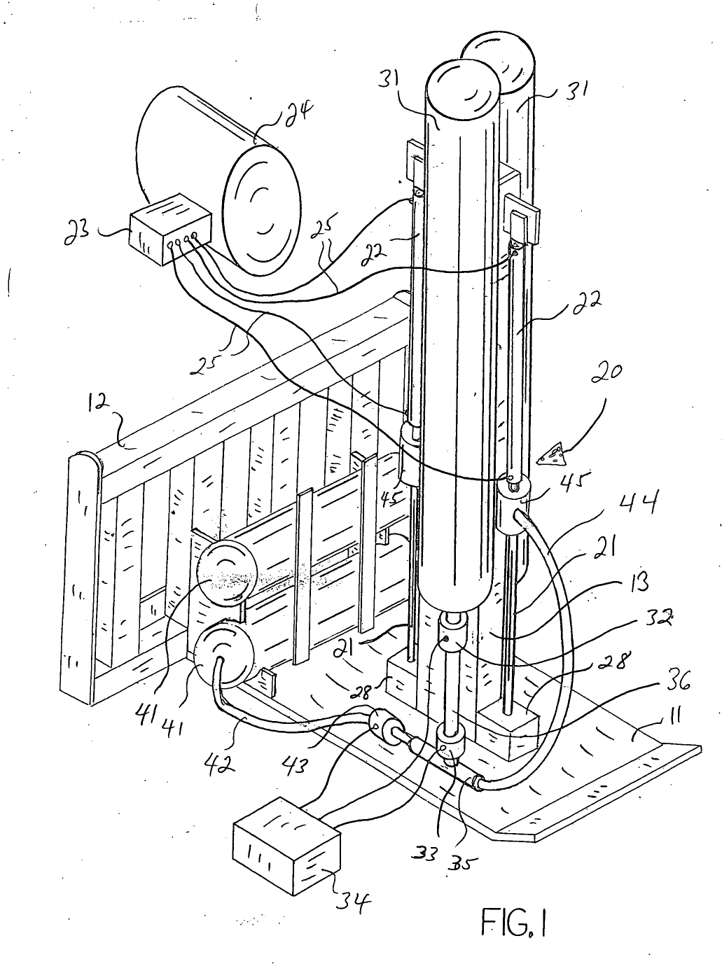

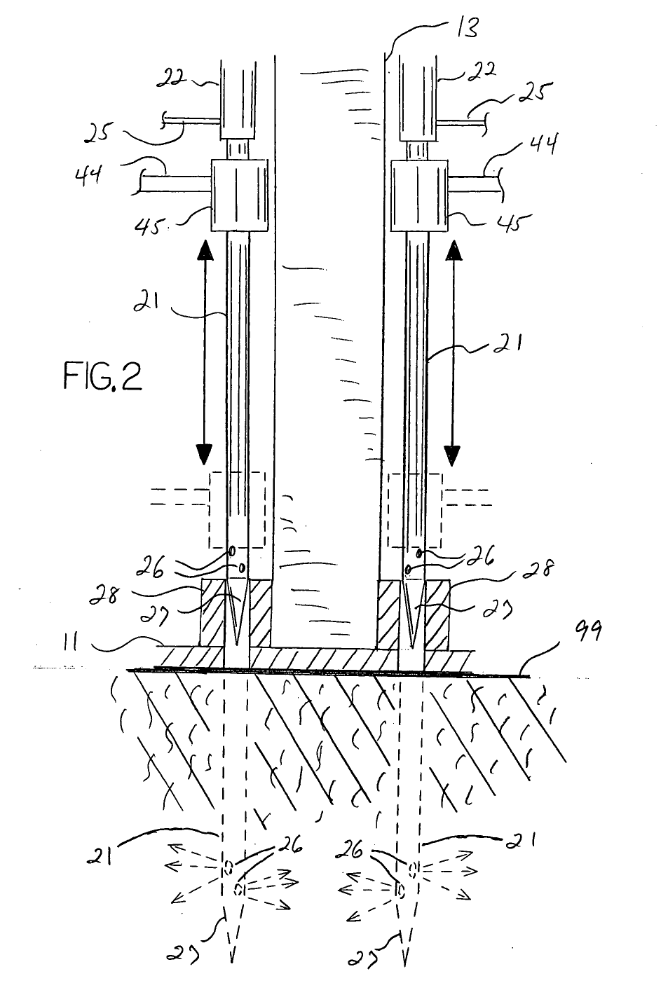

The soil injector apparatus comprises a skid plate or platform 11 provided with mounting means 12 for connecting the invention to an appropriate vehicle in a manner that allows the skid plate 11 to be raised and lowered at least a short distance above the ground for transport and movement of the apparatus from one location to another. A generally vertical support tower 13 extends upwardly from the skid plate 11. At least one and preferably two or more injector systems 20 are mounted to the support tower 13 and/or skid plate 11. Each injector system 20 comprises an injection lance or hollow spike 21 that is reciprocated from a retracted or neutral position to an extended injection position by an hydraulic or similar cylinder 22, operated by lance control means 23 in conjunction with an hydraulic or similar pumping means 24 and fluid conduit means 25, such means and systems being known in the art. The lower portion of the lance 21 is provided with apertures 26 that communicate with the longitudinal bore of the lance 21 such that material can be delivered through the lance 21 and dispersed externally from the apertures 26 under pressure. In the neutral or retracted position, as shown in FIGS. 1 and 2, the tips of the lances 21 are positioned above the bottom of the skid plate 11 and within guides 28, which may be composed of metal, plastic or a combination. In the extended position, as shown by the dashed lines in FIG. 2, the lances 21 extend well beyond the skid plate 11 and beneath the ground surface 99, such that the tips 27 and apertures 27 are positioned from several inches to several feet under the ground surface 99 as desired.

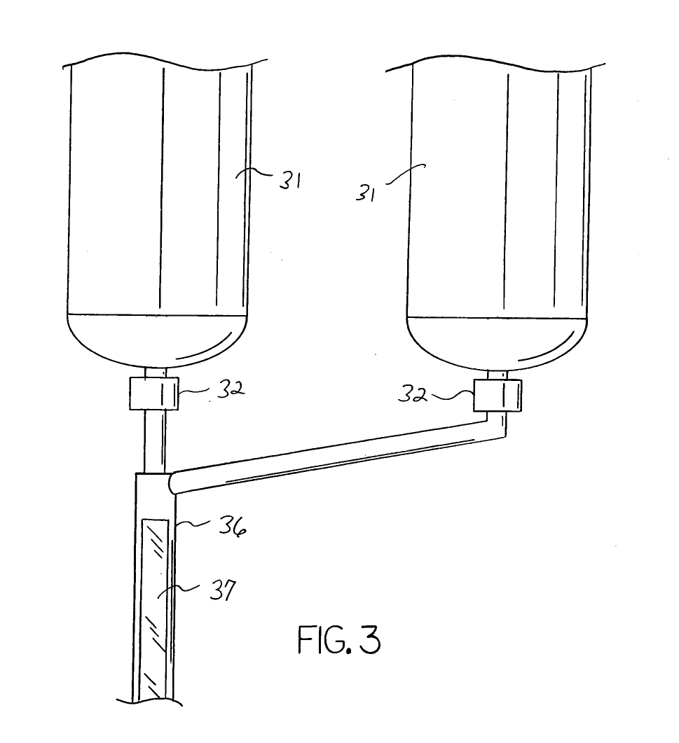

At least one and preferably multiple storage tanks 31 are mounted onto the support tower 13 and/or skid plate 11. Material to be injected, a solid in granular or powder form, a liquid, or a mixture, slurry or the like, is deposited into the storage tanks 31 such that they are distributed from each tank 31 by gravity through a first gated valve 32, such as an electrically controlled ball valve, into a viewing tube 36 or similar retaining member. The viewing tube 36 is composed of a transparent or translucent material or may be provided with a transparent or translucent viewing window 37, and may be calibrated or provided with markings such that the operator can determine and choose the correct amount of injection material for each injection. The apparatus may also be provided with interchangeable viewing tubes 36 of varying volumes. After obtaining the correct amount of material in the viewing tube, either manually using visual observation or by preset control, a second gated valve 33, such as an electrically controlled ball valve, is opened such that the material drops into a firing block reservoir 35. The gating valves 32 and 33 are controlled by injection controller means 34. Each storage tower 31 may have a dedicated first gated valve 32, viewing tube 36, second gated valve 33 and firing block reservoir 35, but it is also possible to configure the apparatus such that plural tanks 31 are fed into a single viewing tube 36 or firing block reservoir 35, such that mixtures of the contents of two storage tanks 31 can be prepared for injection into the ground, as shown in FIG. 3.

The firing block reservoirs 35 are emptied pneumatically by one or more compressed air tanks 41 maintained at pressure by suitable compressor means (not shown) either on the vehicle or separately supplied. Air conduits 42 deliver compressed air to control valves 43 to provide force to deliver the material accumulated in the firing block reservoirs 35 through material conduits 44 into material transfer housings 45 that are mounted on the upper exposed portions of lances 21. The material transfer housings 45 provide a communication pathway from the material conduits 44 to the axial bores within the lances 21, such that when the air control valve 43 is opened by controller means 34, material is delivered into and through the lances 21.

To operate the apparatus, the operator positions the skid plate 11 at the desired location for application of the material and sets the skid plate 11 onto the ground surface 99. The material to be injected is loaded into the viewing tubes 36 by opening first gated valves 32. When the proper amount of material is loaded, first gated valves 32 are closed and second gated valves 33 are opened. The material then drops into the firing block reservoirs 35 and second gated valves 33 are closed. The lances 21 are then driven into the ground by lance control means 23. The air control valves 43 are then opened such that compressed air empties the firing block reservoir 35, driving the material through the material conduits 44, into the lances 21, out of the apertures 26 and into the soil. The lances 21 are then retracted and the apparatus is moved to the next location.

Each injection operation takes only roughly 20 to 30 seconds, since the loading, insertion, injection and retraction operations each take only a few seconds. For large farms, the apparatus provides a significant reduction in the manpower and time required to treat large numbers of trees and plants. The versatility of the apparatus enables the operator to inject a multitude of treating material, whether in liquid, granular solid, powder solid, emulsion, suspension, slurry or multiple other forms.

It is understood that equivalents and substitutions for certain elements described above may be obvious to those skilled in the art, and therefore the true scope and definition of the invention is to be as set forth in the following claims.

I claim:

1. A soil injection apparatus to disperse a material composed of granular or powdered solids, liquids or mixtures of solids and liquids into the ground below the surface, said apparatus comprising:
a skid plate;
mounting means for connection of said skid plate to a vehicle in a manner whereby said skid plate can be raised and lowered;
at least one storage tank retaining material to be injected into the ground;
at least one injection lance reciprocatingly movable between a retracted position and an extended position relative to said skid plate;
means to retract and extend said at least one lance;
means to deliver said material from said at least one storage tank to said at least one injection lance;
means to expel said material from said at least one injection lance and into the ground.

2. The apparatus of claim 1, comprising two said injection lances and two said storage tanks.

3. The apparatus of claim 1, comprising two said storage tanks, wherein material from said two storage tanks is delivered to a single said injection lance.

4. The apparatus of claim 1, wherein said means to deliver said material from said at least one storage tank to said at least one injection lance comprises a viewing tube.

5. The apparatus of claim 4, wherein said means to deliver said material from said at least one storage tank to said at least one injection lance further comprises a first gated valve disposed above said viewing tube controlling entry of said material into said viewing tube and a second gated valve below said viewing tube controlling exiting of said material from said viewing tube.

6. The apparatus of claim 1, wherein said means to deliver said material from said at least one storage tank to said at least one injection lance comprises a firing block reservoir to receive said material from said at least one storage tank and a material transfer housing to deliver said material from said firing block reservoir into said at least one injection lance.

7. The apparatus of claim 5, wherein said means to deliver said material from said at least one storage tank to said at least one injection lance further comprises a firing block reservoir to receive said material from said viewing tube and a material transfer housing to deliver said material from said firing block reservoir into said at least one injection lance.

8. The apparatus of claim 1, wherein said means to expel said material from said at least one injection lance and into the ground comprises at least one compressed air tank and a control valve.

9. The apparatus of claim 7, wherein said means to expel said material from said at least one injection lance and into the ground comprises at least one compressed air tank and a control valve to deliver compressed air into said firing block reservoir and to force said material into said material transfer housing and said at least one injection lance.

10. A soil injection apparatus comprising:
a platform mounted to a vehicle in a manner that allows said platform to be raised from the surface of the ground for movement of said platform to a different location and lowered to the surface of the ground for injection of material into the ground;
means to inject said material into the ground, said means comprising at least one injection lance, said at least one injection lance being reciprocatingly mounted to said platform such that said at least one injection lance can be extended beneath said platform for injection of material into the ground and raised at least even with said platform for movement of said platform to a different location; and
means to extend and retract said at least one injection lance.

11. The apparatus of claim 10, further comprising means to store said material prior to injection of said material into the ground.

12. The apparatus of claim 10, said means to inject said material into said ground comprising means to determine a chosen amount of material for injection.

13. The apparatus of claim 12, said means to determine a chosen amount of material for injection comprising a viewing tube such that said material is visible.

14. The apparatus of claim 13, wherein said viewing tube comprises a viewing window.

15. The apparatus of claim 10, comprising two said injection lances.

16. The apparatus of claim 11, said means to store said material comprising two storage tanks, wherein material from said two storage tanks is delivered to a single said injection lance.

17. The apparatus of claim 13 wherein said means to determine a chosen amount of material comprises a first gated valve disposed above said viewing tube controlling entry of said material into said viewing tube and a second gated valve below said viewing tube controlling exiting of said material from said viewing tube.

18. The apparatus of claim 13, wherein said means to inject said material into the ground comprises a firing block reservoir to receive said material from said viewing tube and a material transfer housing to deliver said material from said firing block reservoir into said at least one injection lance.

19. The apparatus of claim 18, wherein said means to inject said material into the ground further comprises at least one compressed air tank and a control valve to deliver compressed air into said firing block reservoir and to force said material into said at least one injection lance.

20. A soil injection apparatus to disperse a material composed of granular or powdered solids, liquids or mixtures of solids and liquids into the ground below the surface, said apparatus comprising:
a skid plate;
mounting means for connection of said skid plate to a vehicle in a manner whereby said skid plate can be raised and lowered;
at least one storage tank retaining material to be injected into the ground;
at least one injection lance reciprocatingly movable between a retracted position and an extended position relative to said skid plate;
means to retract and extend said at least one lance;
means to deliver said material from said at least one storage tank to said at least one injection lance comprising a viewing tube such that a specific amount of said material can be provided for injection into the ground, a first gated valve disposed above said viewing tube controlling entry of said material into said viewing tube and a second gated valve below said viewing tube controlling exiting of said material from said viewing tube, and a firing block reservoir to receive said material from said at least one storage tank and a material transfer housing to deliver said material from said firing block reservoir into said at least one injection lance;
means to expel said material from said at least one injection lance and into the ground comprising at least one compressed air tank and a control valve to deliver compressed air into said firing block reservoir and to force said material into said material transfer housing and said at least one injection lance.
